(19) United States
(12) Patent Application Publication
(10) Pub. No.: US 2009/0095143 A1
(43) Pub. Date: Apr. 16, 2009

(54) Musical instrument system

(76) Inventor: Patrick Lay, McMinnville, OR (US)

Correspondence Address: HURLEY RE, 747 SW MILL VIEW WAY, BEND, OR, 97702, US

(21) Appl. No.: 11/717,607

(22) Filed: Mar. 13, 2007

(51) Int. Cl. G09B 15/02

(52) U.S. Cl. 84/476

(57) ABSTRACT

A musical teaching system including a plurality of blocks adjacent one another. Each block includes a graphical representation of upbeat and downbeat, and also includes a graphical representation of a musical beat and a musical note or rest. In one embodiment the blocks are mounted on a shaft and are urged into frictional engagement by shaft mounted springs.

### BACKGROUND OF THE INVENTION

This invention relates to musical instruction and in particular to a method of teaching musical rhythms by use of a set of blocks.

### BRIEF DESCRIPTION OF THE DRAWINGS

FIG. 1 is a front elevational view of a preferred embodiment of the invention in which quarter notes are represented.

FIG. 2 is a front elevational view of a preferred embodiment of the invention in which eighth notes are represented.

FIG. 3 is a front elevational view of a preferred embodiment of the invention in which half notes are represented.

FIG. 4 is a front elevational view of a preferred embodiment of the invention in which alternating eighth notes and eighth rests are represented.

FIG. 5 is a front elevational view of a preferred embodiment of the invention in which alternating eighth rests and eighth notes are represented.

FIG. 6 is a perspective view of a single block and showing the differently colored faces.

FIG. 7 shows the blocks arranged to represent rhythms of intermixed quarter and eighth notes.

FIG. 8 shows the blocks arranged to represent rhythms of quarter notes, eighth notes, eighth rests and quarter rests.

FIG. 9 shows the blocks arranged to represent rhythms of eighth notes, half notes and quarter notes.

FIG. 10 is a front elevational view of a second embodiment of the invention in which each block face is divided into differently colored vertical halves to represent sixteenth notes and/or sixteenth rests.

FIG. 11 shows the blocks of FIG. 10 arranged to represent sixteenth notes.

FIG. 12 shows the blocks of FIG. 10 arranged to represent an eighth note followed by two different sixteenth notes.

FIGS. 13-21 illustrate various combinations of eighth and sixteenth notes and rests that can be represented with this embodiment.

FIG. 22 is a perspective view of another embodiment of the invention wherein a pair of blocks are mounted on a shaft and urged into frictional engagement by springs between adjacent blocks.

FIG. 23 is a side cross-sectional view of yet another embodiment of the invention wherein a plurality of blocks are mounted on a shaft and urged into frictional engagement by springs between adjacent blocks.

### DETAILED DESCRIPTION

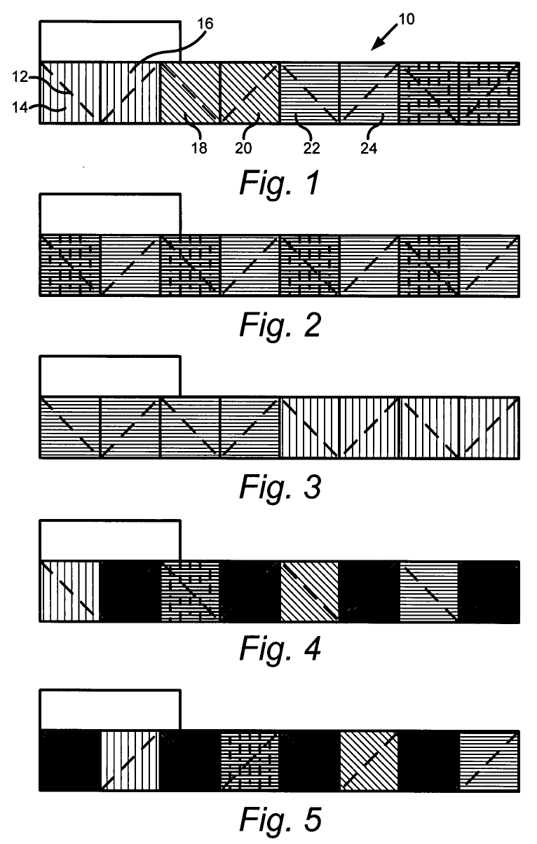

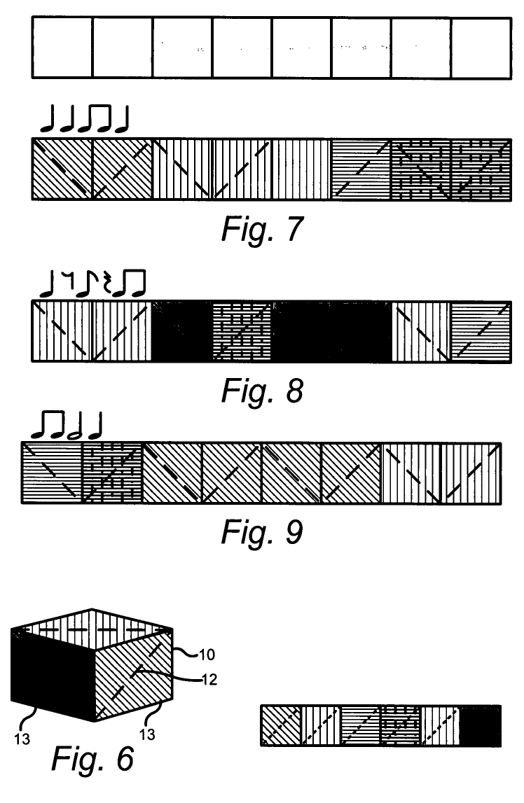

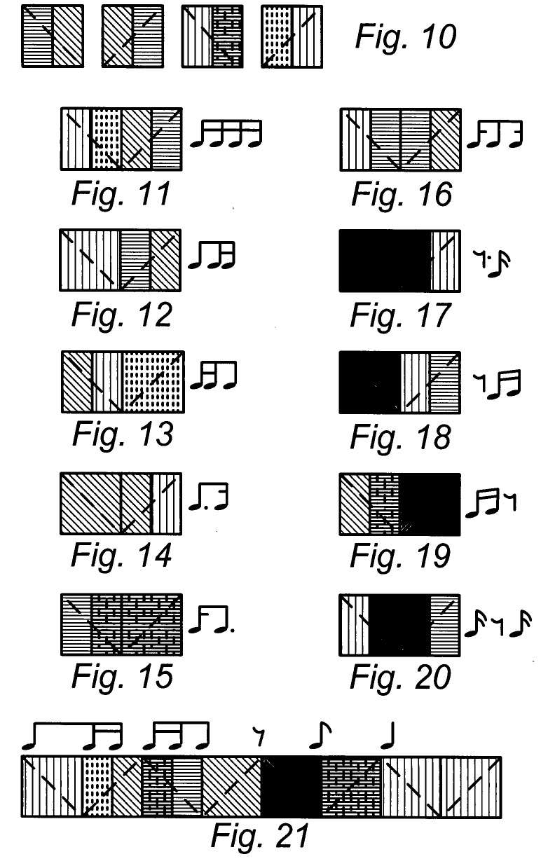

Referring now to FIGS. 1-5, one embodiment of the invention will be described. As seen in FIG. 1, a number of similar blocks 10 are positioned side by side. Referring to FIG. 6 each face of each block 10 is a different color, including one side that is black. The remaining sides also include a diagonal marking 12. Each of the colored faces 13 represents a different musical note. When there is a note change, there is a color change. Each diagonal marking 12 represents an upbeat or a downbeat of a quarter note, depending on whether it is angled upwardly or downwardly. This embodiment is intended for use with a quarter time beat, but the invention is not limited to any particular beat.

Referring to FIG. 1, a number of cubes are placed side by side to represent a musical progression. In FIG. 1 the cubes represent quarter notes. The first block 14 is a downbeat of a first note as indicated by the orientation of the diagonal 12. The second block 16 is the upbeat of the first quarter note as indicated by the upward orientation of diagonal 12. Together, blocks 14 and 16 represent a quarter note. Blocks 18 and 20 represent a second quarter note count, but in a different musical note, as do the following block pairs 22 and 24.

Referring now to FIG. 2, the cubes are arranged to represent eighth notes. In this instance the eighth notes are two alternating musical notes as indicated by the repeating pattern of two differently colored block faces. In FIG. 3 the cubes are arranged to represent half notes in quarter time as indicated by placing two sets of 4 like-colored faces together.

Referring to FIGS. 4 and 5, each block includes one face that is black to represent a rest. In FIG. 4 the blocks are arranged to indicate alternating eighth notes and eighth rests, with a note change after each rest. FIG. 5 shows blocks arranged to show alternating eighth rests and eighth notes, again with a note change after each rest.

Referring now to FIGS. 7-9, the blocks in each figure are arranged to illustrated rhythms of intermixed quarter and eighth notes (FIG. 7), quarter notes, eighth notes, eighth rests and quarter rests (FIG. 8), and eighth notes, half notes and quarter notes (FIG. 9). Any desired combination can be achieved by the appropriate ordering of blocks.

Referring now to FIGS. 13-21, in an alternate embodiment of the invention the block faces divided in half vertically, with each half representing a sixteenth beat in the form of either a note or a rest. The rhythm represented in each of FIGS. 13-21 is shown adjacent the colored blocks. By combining the first and second described embodiments intermediate and advance students can practice a wide variety of rhythm patterns on literally any musical instrument.

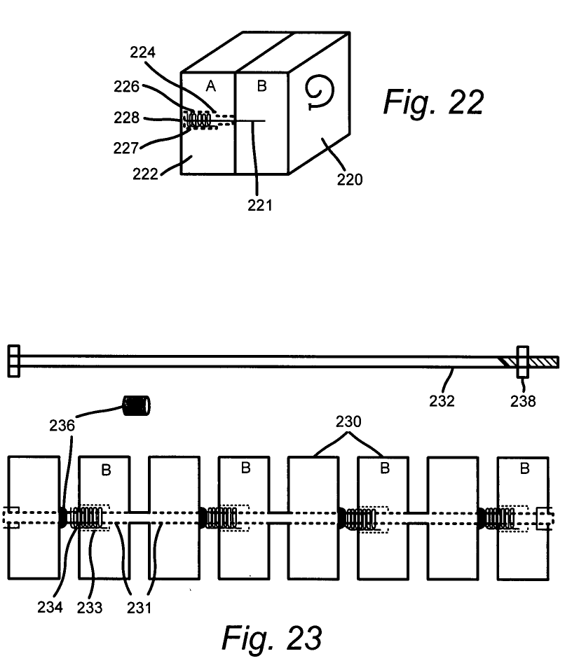

Referring now to FIGS. 22 and 23, in another preferred embodiment of the invention a plurality of blocks 10 are mounted on a common shaft and each block is operable to rotate to display a desired face. In FIG. 22, two blocks 220 and 222 are joined on a single shaft 221. Block 220 is drilled to include a through hole 224 and a channel 226 larger that is larger than shaft 221. Shaft 221 passes through hole 224 and is firmly fixed into block 220. In the illustrated embodiment shaft 221 is a headed nail, and a spring 227 is positioned beneath the head 228, and urges blocks 220 and 222 into frictional engagement, allowing them to be rotated into a desired configuration and held there by the frictional forces created by spring 227. FIG. 22 is a single half beat block that can be used to indicate a downbeat.

FIG. 23 illustrates an embodiment in which a plurality of blocks 230 are mounted on a single shaft 232. Each block is drilled to receive shaft 232 in opening 231, and every second block includes a larger diameter opening 233 to receive a spring 234. A spacer 236 is provided between pairs of adjacent blocks. A spring 234 and spacer 236 are positioned in each opening 233. Shaft 232 is inserted through the blocks and nut 238 is threaded onto shaft 232 to hold the assembly together. In this embodiment the various blocks can be rotated into any desired combination of beats, notes and rests, and temporarily held in place by the frictional forces provided by springs 234. The device as described can be easily stored and is readily portable.

Those of skill in the art will recognize that the described embodiments could be varied in appearance or detail without departing from the scope of the invention, and the invention is not intended to be limited to the illustrated embodiments.

1. A musical instructional system comprising a plurality of blocks, each block comprising;
a plurality of faces, each face having a diagonal marking which when oriented in a first position represents an upbeat and which when oriented in a second position represents a downbeat;
each block having a plurality of faces representing musical notes; and,
the plurality of block operable to position different respective block faces adjacent one another to represent a predetermined rhythmic musical pattern.

2. A musical instructional system according to claim 1 wherein the plurality of block faces includes a face representing a rest.

3. A musical instructional system according to claim 1 wherein the plurality of block faces includes a face representing an half beat of time.

4. A musical instructional system according to claim 1 wherein the plurality of block faces includes a face representing a sixteenth note.

5. A musical instructional system according to claim 1 wherein the plurality of block faces includes a plurality of different appearing faces, each different appearing face representing a change in note.

6. A musical instructional system according to claim 5 wherein the different appearing faces comprise differently colored faces.

7. A musical instructional system according to claim 5 wherein the different appearing faces comprise differently patterned faces.

8. A musical instructional system according to claim 4 wherein the face representing an sixteenth note includes differently colored face portions.

9. A musical instructional system according to claim 1 wherein the plurality of block faces are operable to represent a predetermined rhythmic pattern selected from the group consisting of quarter notes, eighth notes, sixteenth notes, quarter rests, eighth rests, and sixteenth rests.

10. A musical instructional system comprising:
a plurality of blocks;
each block comprising a plurality of faces, each face having a diagonal marking which when oriented in a first position represents an upbeat and which when oriented in a second position represents a downbeat;
each block having a plurality of faces;
a shaft passing through each block; and,
the plurality of block rotatable on the shaft to position different respective block faces adjacent one another to represent a predetermined rhythmic musical pattern.

11. A musical instructional system according to claim 10 wherein the plurality of block faces includes a face representing a rest.

12. A musical instructional system according to claim 10 wherein the plurality of block faces includes a face representing an half beat of time.

13. A musical instructional system according to claim 10 wherein the plurality of block faces includes a face representing a sixteenth note.

14. A musical instructional system according to claim 10 wherein the plurality of block faces includes a plurality of different appearing faces, each different appearing face representing change of notes.

15. A musical instructional system according to claim 14 wherein the different appearing faces comprise differently colored faces.

16. A musical instructional system according to claim 14 wherein the different appearing faces comprise differently patterned faces.

17. A musical instructional system according to claim 13 wherein the face representing a sixteenth note includes differently colored face portions.

18. A musical instructional system according to claim 10 wherein the plurality of block faces are operable to represent a predetermined rhythmic pattern selected from the group consisting of quarter notes, eighth notes, sixteenth notes, quarter rests, eighth rests, and sixteenth rests.

19. A musical instructional system according to claim 10 further comprising a spring mounted on the shaft and urging adjacent blocks into frictional engagement.
